(19) United States
(12) Patent Application Publication
(10) Pub. No.: US 2026/0078692 A1
(43) Pub. Date: Mar. 19, 2026

(54) EXHAUST PURIFICATION DEVICE

(71) Applicant: SUBARU CORPORATION, Tokyo (JP)

(72) Inventor: Shingo SHIMIZU, Tokyo (JP)

(21) Appl. No.: 19/272,049

(22) Filed: Jul. 17, 2025

(30) Foreign Application Priority Data
Sep. 13, 2024 (JP) 2024-159571

(51) Int. Cl. F01N 3/20; F01N 3/28

(52) U.S. Cl. CPC F01N 3/2013; F01N 3/2053; F01N 3/2803; F01N 2270/02; F01N 2900/1626

(57) ABSTRACT

An exhaust purification device for a vehicle with an engine and an electric motor includes: an electrically heated catalyst that is heated by power supply to purify engine exhaust at a predetermined activation temperature or higher; an exhaust pipe with a vacuum layer covering at least an entire side surface of the catalyst; first and second opening/closing valves; and a control unit that controls the power supply and driving of the valves. Upon closing the valves after the vehicle is stopped and the engine is shut down, , the control unit drives the motor to motor the engine and discharge combustion gas from the engine and exhaust pipe, and replaces it with fresh air. The control unit then closes the second valve to heat the catalyst to a target temperature, and thereafter, when the temperature reaches the target temperature, stops the power supply and closes the first valve.

### CROSS-REFERENCE TO RELATED APPLICATIONS

The present application claims priority from Japanese Patent Application No. 2024-159571 filed on September 13, 2024, the entire contents of which are hereby incorporated by reference.

### BACKGROUND

The disclosure relates to an exhaust purification device for purifying engine exhaust, and more particularly to an exhaust purification device equipped with an electrically heated catalyst.

In recent years, emission regulations have demanded a reduction in emissions during cold start (low-temperature start-up). For example, regulatory tightening is advancing with tests such as the Cold Federal Test Procedure (FTP) in North America and the -10°C Real Driving Emissions (RDE) in Europe.

To meet such regulatory tightening, the use of electrically heated catalysts (such as one described in Japanese Unexamined Patent Application Publication No. 11-062565) has been proposed, which can be heated (warmed up) electrically. Here, the electrically heated catalyst (EHC) can be heated to its activation temperature (for example, around 300°C to 500°C) in a short period of time (several seconds to tens of seconds). In the meanwhile, since the heating of the electrically heated catalyst entails a large amount of power (large amount of current), if the power consumed by the heating of the electrically heated catalyst is replenished (charged) by power generation from the engine, there is a risk of deteriorating fuel efficiency.

Therefore, for example, by covering the electrically heated catalyst with a dual exhaust pipe (for example, refer to Japanese Unexamined Patent Application Publication No. 11-132039), which forms a vacuum chamber between an inner pipe and outer pipe, and sealing it with a plug when the vehicle is stopped to provide thermal insulation, the temperature drop of the electrically heated catalyst can be suppressed (keeping the temperature warm), thus reducing the power consumed for heating the electrically heated catalyst during the next engine start.

### SUMMARY

An aspect of the disclosure provides an exhaust purification device, configured to be installed in a vehicle including an engine and an electric motor capable of power transmission to and from a crankshaft of the engine. The exhaust purification device includes an electrically heated catalyst, an exhaust pipe, a first opening/closing valve, a second opening/closing valve, and a control unit. The electrically heated catalyst is configured to be heated by power supply, and to purify exhaust of the engine at a predetermined activation temperature or higher. The exhaust pipe has a vacuum layer that covers at least an entire side surface of the electrically heated catalyst. The first opening/closing valve is disposed upstream of the electrically heated catalyst in the exhaust pipe and configured to open and close the exhaust pipe. The second opening/closing valve is disposed downstream of the electrically heated catalyst in the exhaust pipe and configured to open and close the exhaust pipe. The control unit is configured to control the power supply to the electrically heated catalyst and driving of the first opening/closing valve and the second opening/closing valve. The control unit is configured to, when closing the first opening/closing valve and the second opening/closing valve after the vehicle is stopped and the engine is shut down, drive the electric motor to motor the engine, discharge residual combustion gas from inside the engine and the exhaust pipe, and replace the residual combustion gas with fresh air. The control unit is configured to then close the second opening/closing valve to heat the electrically heated catalyst to a first target temperature. The control unit is configured to, thereafter, when a temperature of the electrically heated catalyst reaches the first target temperature, to stop the power supply to the electrically heated catalyst, and close the first opening/closing valve.

An aspect of the disclosure provides an exhaust purification device configured to be installed in a vehicle including an engine and an electric motor capable of power transmission to and from a crankshaft of the engine. The exhaust purification device includes an electrically heated catalyst, an exhaust pipe, a first opening/closing valve, a second opening/closing valve, and circuitry. The electrically heated catalyst is configured to be heated by power supply, and to purify exhaust of the engine at a predetermined activation temperature or higher. The exhaust pipe has a vacuum layer that covers at least an entire side surface of the electrically heated catalyst. The first opening/closing valve is disposed upstream of the electrically heated catalyst in the exhaust pipe and configured to open and close the exhaust pipe. The second opening/closing valve is disposed downstream of the electrically heated catalyst in the exhaust pipe and configured to open and close the exhaust pipe. The circuitry is configured to control the power supply to the electrically heated catalyst and driving of the first opening/closing valve and the second opening/closing valve. The circuitry is configured to, when closing the first opening/closing valve and the second opening/closing valve after the vehicle is stopped and the engine is shut down, drive the electric motor to motor the engine, discharge residual combustion gas from inside the engine and the exhaust pipe, and replace the residual combustion gas with fresh air. The circuitry is configured to then close the second opening/closing valve to heat the electrically heated catalyst to a first target temperature. the circuitry is configured to, thereafter, when a temperature of the electrically heated catalyst reaches the first target temperature, stop the power supply to the electrically heated catalyst, and close the first opening/closing valve.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 includes a skeleton diagram illustrating the configuration of a power unit of a hybrid vehicle equipped with an exhaust purification device according to an embodiment, and a block diagram illustrating the configuration of a control system thereof;

FIG. 2 is a diagram illustrating the configuration of the exhaust purification device according to the embodiment and an engine to which the exhaust purification device is applied;

FIG. 3 is a diagram illustrating the configuration of the exhaust purification device according to the embodiment;

FIG. 4 is a diagram (timing chart) for describing a power consumption reduction and freezing prevention process performed by the exhaust purification device according to the embodiment; and

FIG. 5 is a flowchart illustrating the power consumption reduction and freezing prevention process performed by the exhaust purification device according to the embodiment.

### DETAILED DESCRIPTION

Even if the electrically heated catalyst is configured to be enclosed with a dual exhaust pipe and plugs to achieve a thermally insulated structure, there is a risk that the plugs may freeze when the vehicle is stopped (left stationary) for a long period under ultra-low temperatures, preventing the plugs from opening at the next engine start. As a result, the exhaust pipe may become blocked.

The disclosure has been made to resolve the above issues, and it is desirable to provide an exhaust purification device equipped with an electrically heated catalyst, which can reduce the power consumption of the electrically heated catalyst and prevent the exhaust pipe from becoming blocked due to the freezing of the plugs (opening/closing valves).

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

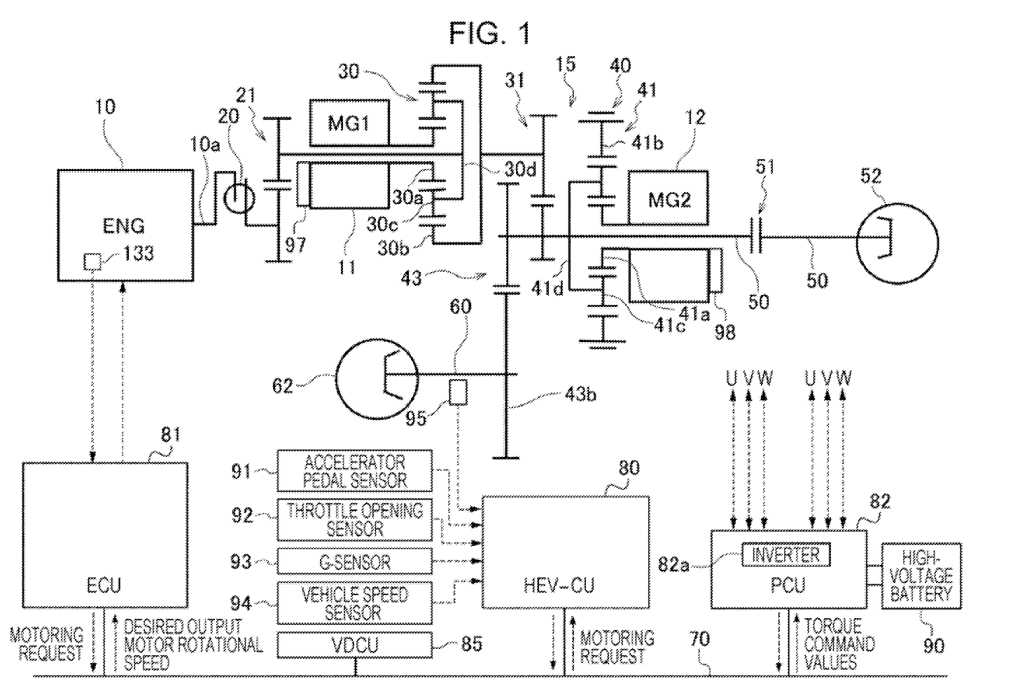

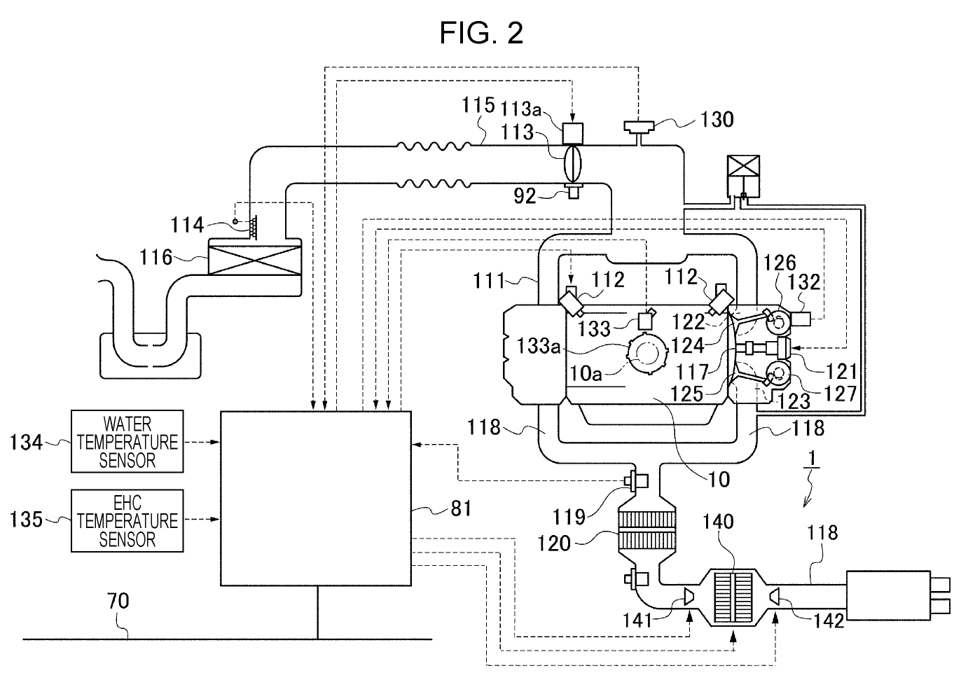

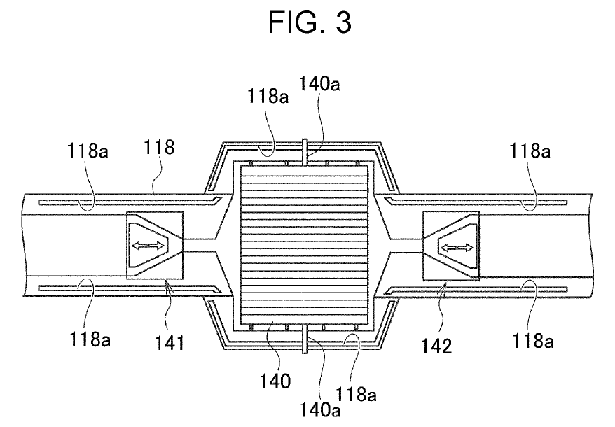

First of all, the configuration of an exhaust purification device 1 according to the embodiment will be described using FIGS. 1 to 3 together. FIG. 1 includes a skeleton diagram illustrating the configuration of a power unit of a hybrid vehicle equipped with the exhaust purification device 1, and a block diagram illustrating the configuration of a control system thereof. FIG. 2 is a diagram illustrating the configuration of the exhaust purification device 1 and an engine 10 to which the exhaust purification device 1 is applied. FIG. 3 is a diagram illustrating the configuration of the exhaust purification device 1. Here, the exhaust purification device 1 will be described using an example in which it is installed in a series-parallel hybrid vehicle (HEV).

First, with reference to FIG. 1, the configuration of the power unit and other components of the hybrid vehicle will be described. A power split mechanism 30 is coupled to a crankshaft 10a of the engine 10 (details will be described later) via a flywheel damper 20, which absorbs rotational fluctuations of the engine 10, and a pair of gears 21. The power split mechanism 30 includes multiple gears, shafts, and other components. A drivetrain 15, which performs torque transmission to and from the drive wheels, and a first motor-generator (MG) 11 (corresponding to an electric motor described in the claims) are coupled to the power split mechanism 30. The power split mechanism 30 includes, for example, a planetary gear mechanism composed of a sun gear 30a, a ring gear 30b, a pinion gear 30c, and a planetary carrier 30d, and splits and transmits the driving torque generated by the engine 10 between the drivetrain 15 and the first motor-generator 11.

In more detail, the planetary carrier 30d is coupled to the crankshaft 10a of the engine 10 via the flywheel damper 20 and the pair of gears 21. The sun gear 30a is coupled to the first motor-generator 11. In the meanwhile, the ring gear 30b is coupled to a propeller shaft (rear wheel output shaft) 50, which forms the drivetrain 15, via a pair of gears (counter gears) 31, and the ring gear 30b is further coupled to a front drive shaft (front wheel output shaft) 60 via a drive reduction gear 43.

The power split mechanism 30, when the first motor-generator 11 serves as a generator (power generator), distributes torque (driving force) from the engine 10, input from the planetary carrier 30d, between the sun gear 30a and the ring gear 30b according to their gear ratios. In the meanwhile, the power split mechanism 30, when the first motor-generator 11 serves as a motor (electric motor), integrates the torque from the engine 10, input from the planetary carrier 30d, and the torque from the first motor-generator 11, input from the sun gear 30a, and outputs the integrated torque to the ring gear 30b. The torque output to the ring gear 30b is output to the propeller shaft 50, which forms the drivetrain 15, via the pair of gears (counter gears) 31, and is further output to the front drive shaft 60 via the drive reduction gear 43.

In the meanwhile, a second motor-generator (MG) 12 (equivalent to the electric motor according to the claims) is additionally coupled to the drivetrain 15. In more detail, the second motor-generator 12 is coupled to the propeller shaft 50 via a motor reduction gear 41. Additionally, the second motor-generator 12 is coupled to the front drive shaft 60 via a drive reduction gear mechanism 40 consisting of the motor reduction gear 41 and the drive reduction gear 43. The front drive shaft 60 performs torque transmission to and from the front wheels. Additionally, the propeller shaft 50 performs torque transmission to and from the rear wheels.

The first motor-generator 11 and the second motor-generator 12 are configured as synchronous power generation motors that combine the function as a motor that converts the supplied electric power into mechanical power and the function as a generator that converts the input mechanical power into electric power. That is, the first motor-generator 11 and the second motor-generator 12 each operate as a motor to generate driving torque during vehicle drive and as a generator during regenerative braking. Note that the first motor-generator 11 operates primarily as a generator, while the second motor-generator 12 operates primarily as a motor.

The drive reduction gear mechanism 40 is configured with the motor reduction gear 41 and the drive reduction gear 43. Additionally, the motor reduction gear 41 is composed of a planetary gear, while the drive reduction gear 43 is composed of, for example, a spur gear (or helical gear).

In more detail, the motor reduction gear 41 has, for example, a planetary gear mechanism composed of a sun gear 41a, a ring gear 41b, a pinion gear 41c, and a planetary carrier 41d. The motor reduction gear 41, when the second motor-generator 12 serves as a motor, reduces the rotation transmitted from the second motor-generator 12 (increasing torque) and outputs it from the planetary carrier 41d. In the meanwhile, the motor reduction gear 41 accelerates the rotation caused by the torque (driving force) input to the planetary carrier 41d (reducing the torque) and outputs it from the sun gear 41a, thereby making the second motor-generator 12 serve as a generator.

The front drive shaft 60 transmits torque between the drive reduction gear mechanism 40 and the drive wheels (front wheels in the example illustrated in FIG. 1). In more detail, the torque transmitted to the front drive shaft 60, such as from the second motor-generator 12, is transmitted to a front differential (hereinafter referred to as "front diff") 62. The front diff 62 is, for example, a bevel-gear differential device. The torque from the front diff 62 is transmitted to the left front wheel (not illustrated) via the left front wheel drive shaft and to the right front wheel (not illustrated) via the right front wheel drive shaft.

In the meanwhile, the propeller shaft 50 performs torque transmission to and from the rear wheels. The propeller shaft 50 is equipped with a transfer clutch 51, which adjusts the torque transmitted to the rear wheels. The transfer clutch 51 controls the engagement force (i.e., the torque distribution ratio to the rear wheels) based on factors such as the drive state of the four wheels (e.g., the slip state of the front wheels) and engine torque. Therefore, the torque transmitted to the propeller shaft 50, such as from the second motor-generator 12, is distributed according to the engagement force of the transfer clutch 51 and transmitted to the rear wheels as well.

In more detail, the torque transmitted to the propeller shaft 50 and adjusted (distributed) by the transfer clutch 51 is transmitted to a rear differential (hereinafter also referred to as "rear diff") 52. A left rear wheel drive shaft and a right rear wheel drive shaft (not illustrated) are coupled to the rear diff 52. The driving force from the rear diff 52 is transmitted to the left rear wheel (not illustrated) via the left rear wheel drive shaft and to the right rear wheel (not illustrated) via the right rear wheel drive shaft.

With the configuration as above, the vehicle (AWD HEV vehicle) according to the present embodiment can drive the front wheels and the rear wheels (vehicle) with the power from the two, i.e., the engine 10 and the second motor-generator 12. Additionally, it is possible to switch between driving (EV driving) by the second motor-generator 12 alone and driving by both the engine 10 and the second motor-generator 12, depending on the driving conditions. Furthermore, power can be generated by the second motor-generator 12 and the like. Additionally, the engine 10 can be motored using the first motor-generator 11 and the like (i.e., the engine 10 can be rotated while the fuel injection and ignition are stopped).

The engine 10, which is the vehicle's driving power source, as well as the second motor-generator 12 and the first motor-generator 11, is comprehensively controlled by a hybrid vehicle control unit (hereinafter referred to as "HEV-CU") 80.

The HEV-CU 80 is configured with a microprocessor that performs operations, an electrically erasable programmable read-only memory (EEPROM) that stores programs for causing the microprocessor to execute processes, a random access memory (RAM) that stores various data such as operation results, a backup RAM that holds the stored contents, an input/output interface (I/F), and so forth.

Various sensors are coupled to the HEV-CU 80, including the following, for example: an accelerator pedal sensor 91, which detects the amount of depression of the accelerator pedal; a throttle opening sensor 92, which detects the opening of the throttle valve; a G-sensor (acceleration sensor) 93, which detects the vehicle's front-rear and left-right acceleration; a vehicle speed sensor 94, which detects the wheel speed; a rotational speed sensor 95, which detects the rotational speed of the front drive shaft 60; a resolver 97, which detects the number of revolutions (rotational speed) of the first motor-generator 11; and a resolver 98, which detects the number of revolutions (rotational speed) of the second motor-generator 12.

Additionally, the HEV-CU 80 is communicatively coupled via a controller area network (CAN) 70 to an engine control unit (hereinafter referred to as "ECU") 81, which controls the engine 10, a vehicle dynamic control unit (hereinafter referred to as "VDCU") 85, which suppresses vehicle skidding and the like to improve driving stability, and the like. The HEV-CU 80 receives various information from the ECU 81 and the VDCU 85, including, for example, engine speed, brake operation amount, and the like, via the CAN 70. In the meanwhile, the HEV-CU 80 transmits various information to the ECU 81, including, for example, the number of revolutions (rotational speed) of the first motor-generator 11, the number of revolutions (rotational speed) of the second motor-generator 12, and the like, via the CAN 70.

Based on these various pieces of information obtained, the HEV-CU 80 comprehensively controls the driving of the engine 10, the second motor-generator 12, and the first motor-generator 11. The HEV-CU 80 determines and outputs the desired output of the engine 10, and the torque command values for the second motor-generator 12 and the first motor-generator 11, based on factors such as the accelerator pedal opening (driver's desired driving force), the vehicle's operating conditions, and the state of charge (SOC) of a high-voltage battery (hereinafter simply referred to as "battery") 90.

A power control unit (hereinafter referred to as "PCU") 82 drives the second motor-generator 12 and the first motor-generator 11 via an inverter 82a based on the torque command values mentioned above. The PCU 82 has the inverter 82a, which converts the direct current (DC) power of the high-voltage battery 90 into three-phase alternating current (AC) power and supplies it to the second motor-generator 12 and the first motor-generator 11. The PCU 82 drives the second motor-generator 12 and the first motor-generator 11 via the inverter 82a based on the torque command values received from the HEV-CU 80, as described above. In the meanwhile, the inverter 82a, during regenerative braking, converts the AC voltage generated by the second motor-generator 12 into DC voltage to charge the high-voltage battery 90.

Additionally, the ECU 81 adjusts the opening of an electronically controlled throttle valve 113, for example, based on the desired output mentioned above. Next, the configuration of the exhaust purification device 1 and the engine 10 to which the exhaust purification device 1 is applied will be described in detail with reference to FIG. 2.

The engine 10, which could be in any form, is a horizontally opposed four-cylinder gasoline engine, for example. Additionally, the engine 10 is an in-cylinder injection engine, where fuel is injected directly into the cylinders. In the engine 10, the air inhaled from an air cleaner 116 is narrowed by the electronically controlled throttle valve (hereinafter simply referred to as "throttle valve") 113 provided in an intake pipe 115, passes through an intake manifold 111, and is inhaled into each cylinder formed in the engine 10. Here, the amount of air inhaled from the air cleaner 116 is detected by an air flow meter 114 disposed between the air cleaner 116 and the throttle valve 113. Additionally, inside a collector section (surge tank) that forms the intake manifold 111, a vacuum sensor 130 is installed to detect the pressure within the intake manifold 111 (intake manifold pressure). Furthermore, the throttle valve 113 is provided with the throttle opening sensor 92 to detect the opening of the throttle valve 113.

The cylinder head is formed with an intake port 122 and an exhaust port 123 for each cylinder (a single bank is illustrated in FIG. 2). Each intake port 122 and each exhaust port 123 are provided respectively with an intake valve 124 and an exhaust valve 125, which opens and closes the intake port 122 and the exhaust port 123. Between an intake camshaft that drives the intake valve 124 and an intake cam pulley, a variable valve timing mechanism 126 is provided to continuously change the rotational phase (displacement angle) of the intake camshaft relative to the crankshaft 10a by relatively rotating the intake cam pulley and the intake camshaft, thereby advancing or delaying the valve timing (opening and closing timing) of the intake valve 124. This variable valve timing mechanism 126 variably sets the opening and closing timing of the intake valve 124 according to the engine operating state.

Similarly, between an exhaust camshaft and an exhaust cam pulley, a variable valve timing mechanism 127 is provided to continuously change the rotational phase (displacement angle) of the exhaust camshaft relative to the crankshaft 10a by relatively rotating the exhaust camshaft and the exhaust cam pulley, thereby advancing or delaying the valve timing (opening and closing timing) of the exhaust valve 125. This variable valve timing mechanism 127 variably sets the opening and closing timing of the exhaust valve 125 according to the engine operating state.

Each cylinder of the engine 10 is equipped with an injector 112, which injects fuel into the cylinder. The injector 112 directly injects fuel, which has been pressurized by a high-pressure fuel pump (not illustrated), into the combustion chamber of each cylinder.

Additionally, the cylinder head of each cylinder is equipped with an ignition plug 117, which ignites the air-fuel mixture, and an igniter-integrated coil 121, which applies a high voltage to the ignition plug 117. In each cylinder of the engine 10, the air-fuel mixture, consisting of the inhaled air and the fuel injected by the injector 112, is ignited by the ignition plug 117 and combusted. The exhaust gas after combustion is discharged through an exhaust pipe 118.

In the present embodiment, the exhaust pipe 118 is designed with a 4-2-1 layout to prevent interference between the exhausts. The exhausts from cylinder #1 and cylinder #2, and from cylinder #3 and cylinder #4, are first merged (collected), and then the two merged streams are further collected into one. Alternatively, instead of the 4-2-1 layout, it is also acceptable to adopt a 4-1 layout or other layouts.

An air-fuel ratio sensor 119 is installed downstream of the collector section of the exhaust pipe 118 and upstream of an exhaust purification catalyst 120, which will be described later. As the air-fuel ratio sensor 119, a linear air-fuel ratio sensor (LAF sensor) is used, which is capable of outputting a signal corresponding to the oxygen concentration and unburned gas concentration in the exhaust gas (i.e., a signal corresponding to the air-fuel ratio of the air-fuel mixture) and detecting the air-fuel ratio in a linear manner.

The exhaust purification catalyst 120 is disposed downstream of the LAF sensor 119. The exhaust purification catalyst 120 is a three-way catalyst (TWC) that simultaneously oxidizes hydrocarbons (HC) and carbon monoxide (CO) in the exhaust gas while reducing nitrogen oxides (NOₓ), thereby purifying harmful gas components in the exhaust gas into harmless carbon dioxide (CO₂), water vapor (H₂O), and nitrogen (N₂).

An electrically heated catalyst (EHC) 140 is disposed downstream of the exhaust purification catalyst 120. By disposing the electrically heated catalyst 140 downstream of the exhaust purification catalyst 120, damage caused by excessive heat during high-load driving can be prevented.

The electrically heated catalyst 140 is configured to be heatable by a heating element (heater) that generates heat when energized (power is supplied) via, for example, a pair of electrodes 140a. The electrically heated catalyst 140 promotes reaching a predetermined activation temperature (e.g., approximately 300°C to 500°C) through heating (warming up) by energization, thereby activating early and exhibiting an effect in reducing emissions (purifying exhaust) immediately after start-up or during warm-up (particularly during cold start).

The electrically heated catalyst 140 is formed in a substantially cylindrical shape and is supported (held) by, for example, multiple rod-shaped insulating support members provided between the electrically heated catalyst 140 and the exhaust pipe 118 (inner circumferential surface) to prevent direct contact (surface contact) with the exhaust pipe 118.

The power supply to the electrically heated catalyst 140 (i.e., the temperature of the electrically heated catalyst 140) is controlled by the ECU 81. Note that details will be described later.

A vacuum layer (hollow structure) 118a, with its interior maintained in a vacuum state, is formed in an area of the exhaust pipe 118 to cover at least the entire side surface of the electrically heated catalyst 140. In the present embodiment, in order to enhance the thermal retention performance by covering a wider area of the electrically heated catalyst 140, vacuum layers 118a are also formed on the upstream and downstream sides of the electrically heated catalyst 140. Note that, in the present embodiment (FIG. 3), the vacuum layer 118a on the side surface of the electrically heated catalyst 140, the vacuum layer 118a on the upstream side, and the vacuum layer 118a on the downstream side are made separable. However, these layers may also be continuous without being separated (they may be joined).

The inner and outer tubes of the exhaust pipe 118, as well as the vacuum layer 118a formed between them, each have a radial cross-section formed in an annular shape. The radial thickness of the vacuum layer 118a is set according to specified factors such as thermal insulation performance (thermal retention performance) and the like.

Note that the exhaust pipe 118 with the vacuum layer 118a can be manufactured, for example, by coupling the inner and outer tubes through welding or the like inside a manufacturing device that has been placed under a vacuum, and then removing them from the device. However, it is also acceptable to couple the inner and outer tubes in the atmosphere and then evacuate the air from the interior (vacuum layer 118a).

A first opening/closing valve 141 is disposed upstream of the electrically heated catalyst 140 in the exhaust pipe 118. The first opening/closing valve 141 opens and closes the exhaust pipe 118 upstream of the electrically heated catalyst 140. The first opening/closing valve 141 is an electromagnetic solenoid valve mainly composed of, for example, a valve body having a truncated conical end surface (seal surface) and being disposed to be movable in the axial direction of the exhaust pipe 118, and an electromagnetic solenoid that drives the valve body in the axial direction. The first opening/closing valve 141 opens when energized and closes when de-energized. The driving (open/close operation) of the first opening/closing valve 141 is controlled by the ECU 81. Details will be described later.

Note that it is preferable that the valve body of the first opening/closing valve 141 be hollow. Additionally, the clearance (stroke amount of the valve body) of the first opening/closing valve 141 (seal section) is set in consideration of factors such as the pressure loss in the exhaust pipe 118.

A second opening/closing valve 142 is disposed downstream of the electrically heated catalyst 140 in the exhaust pipe 118. The second opening/closing valve 142 opens and closes the exhaust pipe 118 downstream of the electrically heated catalyst 140. Like the first opening/closing valve 141 described above, the second opening/closing valve 142 is configured mainly with, for example, a valve body having a truncated conical end surface (seal surface) and being disposed to be movable in the axial direction of the exhaust pipe 118, and an electromagnetic solenoid that drives the valve body in the axial direction. The second opening/closing valve 142 opens when energized and closes when de-energized. The driving (open/close operation) of the second opening/closing valve 142 is controlled by the ECU 81. Details will be described later.

Note that it is preferable that the valve body of the second opening/closing valve 142 be hollow. Additionally, the clearance (stroke amount of the valve body) of the second opening/closing valve 142 (seal section) is set in consideration of factors such as the pressure loss in the exhaust pipe 118.

A muffler (silencer) for reducing exhaust noise is coupled to the rear end of the exhaust pipe 118 (i.e., downstream of the electrically heated catalyst 140). The muffler has multiple partition walls and other components disposed inside a housing, which is formed, for example, in a rectangular, cylindrical, or elliptical cylindrical shape. By gradually expanding the exhaust, repeatedly interfering with pressure waves, and other mechanisms, the muffler reduces the pressure and temperature of the exhaust, thereby lowering exhaust noise. Note that the configuration may be such that a pre-muffler that reduces high-frequency sound may be provided upstream of the muffler (main muffler).

In addition to the air flow meter 114, the LAF sensor 119, the vacuum sensor 130, and the throttle opening sensor 92 described above, a cam angle sensor 132 is installed in the vicinity of the camshaft of the engine 10 to perform cylinder determination of the engine 10. Additionally, a crank angle sensor 133 is installed in the vicinity of the crankshaft 10a of the engine 10 to detect the rotational position of the crankshaft 10a (rotational angular speed and rotational speed obtained from the temporal variation of the rotational position). Here, a timing rotor 133a, for example, with 34 teeth protrusions formed at 10° intervals, but with two teeth missing, is attached to an end of the crankshaft 10a. The crank angle sensor 133 detects the presence or absence of the protrusions on the timing rotor 133a to determine the rotational position of the crankshaft 10a. As the cam angle sensor 132 and the crank angle sensor 133, electromagnetic pickup sensors or similar sensors may be used, for example.

These sensors are coupled to the ECU 81. Furthermore, various sensors, such as a water temperature sensor 134, which detects the temperature of the cooling water of the engine 10, and an EHC temperature sensor 135, which detects the temperature of the electrically heated catalyst 140, are also coupled to the ECU 81. Additionally, the ECU 81 receives information from the HEV-CU 80, including the desired output, the number of revolutions (rotational speed) of the first motor-generator 11, the number of revolutions (rotational speed) of the second motor-generator 12, the accelerator pedal opening, and the like, via the CAN 70.

The ECU 81 is configured with a microprocessor that performs operations, an EEPROM that stores programs for causing the microprocessor to execute processes, a RAM that stores various data such as operation results, a backup RAM that holds the stored contents, an input/output I/F, and so forth. The ECU 81 also includes an injector driver that drives the injector 112, an output circuit that outputs an ignition signal, a motor driver that drives an electric motor 113a configured to open and close the electronically controlled throttle valve 113, and the like. Furthermore, the ECU 81 includes a driver (circuit) that turns on and off the power supply to the electrically heated catalyst 140, and a driver that drives (opens and closes) the first opening/closing valve 141 and the second opening/closing valve 142.

In the ECU 81, the cylinder is determined based on the output of the cam angle sensor 132, and the rotational angular speed and engine speed are calculated based on the output of the crank angle sensor 133. Additionally, in the ECU 81, various types of information, such as the amount of intake air, the negative pressure of the intake pipe, the air-fuel ratio of the air-fuel mixture, and the water temperature of the engine 10, are obtained based on detection signals input from the various sensors described above. The ECU 81 then controls the engine 10 by controlling the fuel injection amount, ignition timing, and various devices such as the throttle valve 113, based on the desired output from the HEV-CU 80 and these pieces of various information obtained. The ECU 81 also controls the power supply to the electrically heated catalyst 140 (temperature of the electrically heated catalyst 140) and the driving (open/close operation) of the first opening/closing valve 141 and the second opening/closing valve 142.

In particular, the ECU 81 can reduce the power consumption of the electrically heated catalyst 140 and has the function of preventing the exhaust pipe 118 from being blocked by the freezing of the first opening/closing valve 141 and the second opening/closing valve 142. In the ECU 81, this function is implemented by a program, stored in the EEPROM or the like, being executed by the microprocessor.

After the vehicle is stopped and the engine 10 is shut down, when closing the first opening/closing valve 141 and the second opening/closing valve 142, the ECU 81 first drives the first motor-generator 11 and the like (outputs a drive request to the HEV-CU 80) to motor the engine 10, discharges the residual combustion gas from inside the engine 10 and the exhaust pipe 118, and replaces it with fresh air. Note that it is preferable to open the throttle valve 113 when motoring the engine 10.

Accordingly, combustion gas containing a large amount of water vapor is discharged and replaced with fresh air containing a small amount of water vapor, thereby reducing the amount of internal water vapor that could cause freezing, and preventing the freezing of components such as the first and second opening/closing valves 141 and 142.

The ECU 81 then closes the second opening/closing valve 142 to heat the electrically heated catalyst 140 to a first target temperature (e.g., 600°C), stops the power supply to the electrically heated catalyst 140 once the temperature of the electrically heated catalyst 140 reaches the first target temperature, and closes the first opening/closing valve 141.

In this way, after the electrically heated catalyst 140 is heated to the first target temperature, the first and second opening/closing valves 141 and 142 are closed (sealing the electrically heated catalyst 140). Thereafter, the temperature gradually decreases (natural cooling), causing the internal pressure to drop (depressurization), which reduces heat conduction through the air and improves thermal retention, thereby reducing the power consumption of the electrically heated catalyst 140. In particular, since the second opening/closing valve 142 remains closed at that time (when the electrically heated catalyst 140 is being heated), condensed water that accumulates in the rearward side of the exhaust pipe 118 (such as in the muffler), where condensed water tends to accumulate, is evaporated again by the heat from the heating process. This prevents the condensed water from entering the second opening/closing valve 142 and other components, thereby preventing freezing.

In this state, where the internal pressure is reduced, heat conduction is lowered (improving thermal retention), and the amount of internal water vapor is reduced, the electrically heated catalyst 140 is sealed and thermally insulated to retain heat (i.e., a so-called thermos bottle structure is formed) by the exhaust pipe 118, which has the vacuum layer 118a, along with the first opening/closing valve 141 and the second opening/closing valve 142. This reduces the power consumption of the electrically heated catalyst 140, and even if the electrically heated catalyst 140 is left under ultra-low temperatures for a long period, the first opening/closing valve 141 and the second opening/closing valve 142 are prevented from freezing and becoming unable to open.

Additionally, as mentioned above, after the temperature of the electrically heated catalyst 140 reaches the first target temperature and the power supply to the electrically heated catalyst 140 is stopped, if the temperature of the electrically heated catalyst 140 decreases (natural cooling) from the first target temperature to a second target temperature (e.g., around 350°C), the ECU 81 controls the power supply to the electrically heated catalyst 140 so as to maintain the second target temperature.

Then, the ECU 81 controls the power supply to the electrically heated catalyst 140 such that the temperature of the electrically heated catalyst 140 is maintained at the second target temperature until the engine 10 is started next (while the vehicle is stopped). As a result, sudden power supply (heating output) for a short period of time during the next engine start becomes unnecessary. In other words, it is no longer necessary to increase the temperature (heating) by several hundred degrees in a few seconds, for example.

However, when the charge amount (SOC) of the battery 90 drops to a predetermined value or lower (i.e., to a level where the next engine start becomes difficult) while the electrically heated catalyst 140 is being maintained at the second target temperature, the ECU 81 stops the power supply to (temperature maintenance of) the electrically heated catalyst 140 and opens the first opening/closing valve 141 and the second opening/closing valve 142.

In the meanwhile, after the ECU 81 closes the first opening/closing valve 141 and the second opening/closing valve 142, when the engine 10 is started next, that is, during the engine start or just before the engine start, more precisely, for example, simultaneously with the start of cranking (when the push switch is pressed), the ECU 81 opens the first opening/closing valve 141 and the second opening/closing valve 142. Additionally, when the electrically heated catalyst 140 is maintained at the second target temperature, the ECU 81 stops the power supply to the electrically heated catalyst 140 upon start-up of the engine 10.

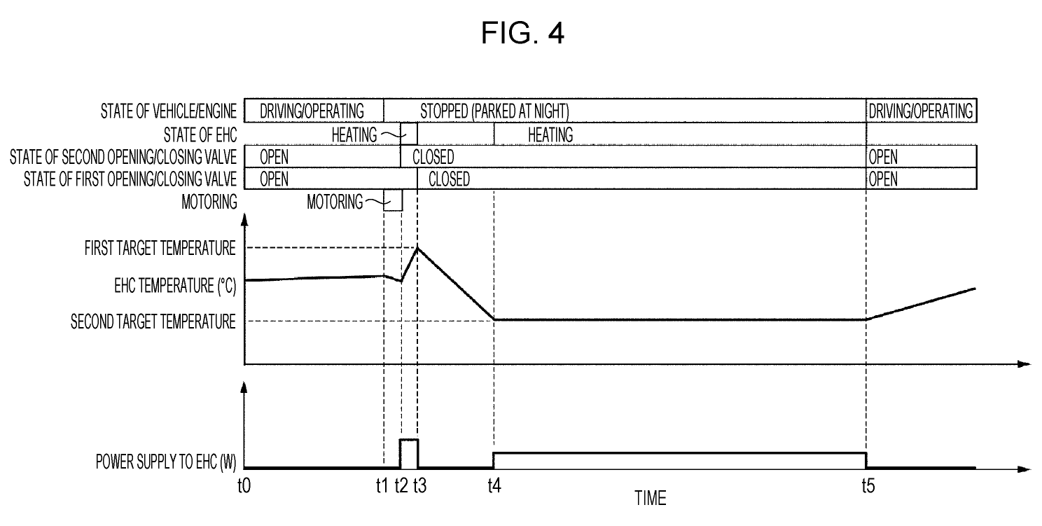

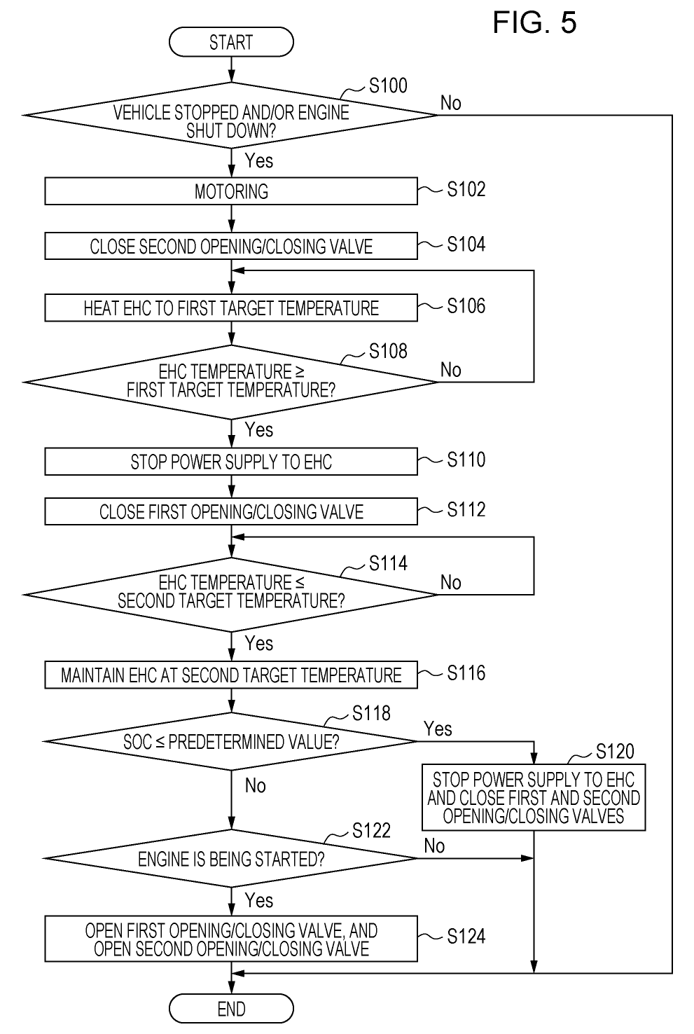

Next, the operation of the exhaust purification device 1 will be described with reference to FIGS. 4 and 5 together. FIG. 4 is a diagram (timing chart) for describing a power consumption reduction and freezing prevention process performed by the exhaust purification device 1. Here, the horizontal axis in FIG. 4 represents time (clock), and the vertical axis represents the following from top to bottom: the state (driving/operating or stopped) of the vehicle/engine 10; the energization state of the electrically heated catalyst 140; the state (open or closed) of the first opening/closing valve 141; the state (open or closed) of the second opening/closing valve 142; the temperature (°C) of the electrically heated catalyst 140; and the power (W) supplied to the electrically heated catalyst 140. FIG. 5 is a flowchart illustrating the power consumption reduction and freezing prevention process performed by the exhaust purification device 1. This process is repeatedly performed at a predetermined timing mainly by the ECU 81.

First, in step S100, it is determined whether the vehicle is stopped and the engine 10 is shut down. Here, if the vehicle is not stopped and/or the engine 10 is not shut down (refer to the time period from t0 to t1 in FIG. 4), the ECU 81 temporarily exits from the current process. On the other hand, if the vehicle is stopped and the engine 10 is shut down (refer to the time t1 in FIG. 4), the process transitions to step S102.

In step S102, the first motor-generator 11 and the like are driven for a predetermined period to motor the engine 10, and the residual combustion gas is discharged from inside the engine 10 and the exhaust pipe 118 and replaced with fresh air (refer to the time period from t1 to t2 in FIG. 4).

Next, in step S104, the second opening/closing valve 142 is closed (refer to the time t2 in FIG. 4). Note that the first opening/closing valve 141 remains open.

Then, in step S106, power is supplied to the electrically heated catalyst 140 and the electrically heated catalyst 140 is heated (warmed up) to the first target temperature (refer to the time period from t2 to t3 in FIG. 4).

Next, in step S108, it is determined whether the electrically heated catalyst 140 has been heated to the first target temperature. Here, if the temperature of the electrically heated catalyst 140 has not reached the first target temperature, the process transitions to step S106, where the electrically heated catalyst 140 is heated until the temperature of the electrically heated catalyst 140 reaches the first target temperature. On the other hand, when the temperature of the electrically heated catalyst 140 has reached the first target temperature (refer to the time t3 in FIG. 4), the process transitions to step S110.

In step S110, the power supply to the electrically heated catalyst 140 is stopped (refer to the time t3 in FIG. 4). Then, in step S112, the first opening/closing valve 141 is closed (refer to the time t3 in FIG. 4).

Next, in step S114, it is determined whether the temperature of the electrically heated catalyst 140 has dropped to the second target temperature. Here, if the temperature of the electrically heated catalyst 140 has not dropped to the second target temperature, this step is repeatedly executed until the temperature of the electrically heated catalyst 140 drops to the second target temperature. On the other hand, when the temperature of the electrically heated catalyst 140 drops to the second target temperature (refer to the time t4 in FIG. 4), the process transitions to step S116.

In step S116, the power supplied to the electrically heated catalyst 140 is regulated (controlled) such that the temperature of the electrically heated catalyst 140 is maintained at the second target temperature.

Next, in step S118, it is determined whether the SOC of the battery 90 has dropped to a predetermined value or lower (to a level where the next engine start becomes difficult). Here, if the SOC of the battery 90 has dropped to the predetermined value or lower, in step S120, the power supply to (temperature maintenance of) the electrically heated catalyst 140 is stopped, and the first opening/closing valve 141 and the second opening/closing valve 142 are closed. Thereafter, the ECU 81 exits from the current process. On the other hand, when the SOC of the battery 90 has not dropped to the predetermined value or lower, the process transitions to step S122.

In step S122, it is determined whether the engine 10 is being started (whether it is at the time of engine start or just before the engine start). Here, if the engine 10 is not being started, the ECU 81 temporarily exits from the current process. On the other hand, when the engine 10 is being started (refer to the time t5 in FIG. 4), the process transitions to step S124.

In step S124, the first opening/closing valve 141 is opened, and the second opening/closing valve 142 is opened (refer to the time period from t5 onward in FIG. 4). Thereafter, the ECU 81 exits from the current process.

As described above in detail, according to the present embodiment, first, after the vehicle is stopped and the engine 10 is shut down, when (before) closing the first opening/closing valve 141 and the second opening/closing valve 142, the first motor-generator 11 and the like are driven to motor the engine 10, and the residual combustion gas is discharged from inside the engine 10 and the exhaust pipe 118 and replaced with fresh air. Accordingly, combustion gas containing a large amount of water vapor is discharged and replaced with fresh air containing a small amount of water vapor, thereby reducing the amount of internal water vapor that could cause freezing, and preventing the freezing of components such as the first and second opening/closing valves 141 and 142.

Next, the second opening/closing valve 142 is closed to heat the electrically heated catalyst 140 to the first target temperature. Thereafter, when the temperature of the electrically heated catalyst 140 reaches the first target temperature, the power supply to the electrically heated catalyst 140 is stopped, and the first opening/closing valve 141 is closed. In this way, after the electrically heated catalyst 140 is heated to the first target temperature, the first and second opening/closing valves 141 and 142 are closed (sealing the electrically heated catalyst 140). Thereafter, the temperature gradually decreases (natural cooling), causing the internal pressure to drop (depressurization), which reduces heat conduction through the air and improves thermal retention, thereby reducing the power consumption of the electrically heated catalyst 140. In particular, since the second opening/closing valve 142 remains closed at that time (when the electrically heated catalyst 140 is being heated), condensed water that accumulates in the rearward side of the exhaust pipe 118 (such as in the muffler), where condensed water tends to accumulate after the exhaust gas is cooled, is evaporated again by the heat from the heating process. This prevents the condensed water from entering the second opening/closing valve 142 and other components, thereby preventing freezing.

In this state, where the internal pressure is reduced, heat conduction is lowered (improving thermal retention), and the amount of internal water vapor is reduced, the electrically heated catalyst 140 is sealed and thermally insulated to retain heat (i.e., a so-called thermos bottle structure is formed) by the exhaust pipe 118, which has the vacuum layer 118a, along with the first opening/closing valve 141 and the second opening/closing valve 142. This reduces the power consumption of the electrically heated catalyst 140, and even if the electrically heated catalyst 140 is left under ultra-low temperatures for a long period, the first opening/closing valve 141 and the second opening/closing valve 142 are prevented from freezing and becoming unable to open.

As a result, it becomes possible to reduce the power consumption of the electrically heated catalyst 140 and to prevent the exhaust pipe 118 from being blocked (furthermore, to prevent the engine 10 (particularly the exhaust system) from being damaged) by the freezing of the first opening/closing valve 141 and the second opening/closing valve 142.

According to the present embodiment, after the temperature of the electrically heated catalyst 140 reaches the first target temperature and the power supply to the electrically heated catalyst 140 is stopped, if the temperature of the electrically heated catalyst 140 decreases from the first target temperature to the second target temperature (for example, around 350°C), the power supply to the electrically heated catalyst 140 is controlled to maintain the second target temperature. Additionally, the power supply to the electrically heated catalyst 140 is controlled such that the temperature of the electrically heated catalyst 140 is maintained at the second target temperature until the engine 10 is started next. Therefore, sudden power supply (heating output) for a short period of time during the next engine start becomes unnecessary. In other words, it is no longer necessary to increase the temperature (heating) by several hundred degrees in a few seconds, for example.

According to the present embodiment, after the first opening/closing valve 141 and the second opening/closing valve 142 are closed, when the engine 10 is started next, the first opening/closing valve 141 and the second opening/closing valve 142 are opened, thereby preventing the exhaust pipe 118 from being blocked during engine operation.

According to the present embodiment, when the power supply to the electrically heated catalyst 140 is controlled such that the temperature of the electrically heated catalyst 140 is maintained at the second target temperature, if the charge amount (SOC) of the battery 90 supplying power to the electrically heated catalyst 140, the first motor-generator 11, and the like drops to a predetermined value or lower, the power supply to the electrically heated catalyst 140 is stopped, and the first opening/closing valve 141 and the second opening/closing valve 142 are opened. Therefore, it becomes possible to prevent the engine 10 from becoming unable to start and the exhaust pipe 118 from remaining blocked.

The above describes the embodiment of the disclosure; however, the disclosure is not limited to the above embodiment, and various modifications are possible. For example, in the above embodiment, the exhaust purification device 1 according to the disclosure has been described with reference to its application to a series-parallel hybrid vehicle (HEV). However, as long as the engine 10 can be motored (rotated by an electric motor), the disclosure can also be applied to hybrid vehicles in different formats (such as parallel hybrid vehicles) or plug-in hybrid vehicles (PHEVs) that can be charged from an external source. Likewise, in the above embodiment, there are two electric motors (the first motor-generator 11 and the second motor-generator 12), but the number of electric motors is not limited to two (two motors); it can be one (one motor) or three (three motors) or more. Furthermore, the disclosure can also be applied to a so-called mild hybrid equipped with an Integrated Starter-Generator (ISG), which serves as both a starter and a generator.

Additionally, the system configuration of controllers such as the HEV-CU 80 and the ECU 81, as well as the division of functions among the controllers, are not limited to the above embodiment. For example, in the above embodiment, the power supplied to (temperature of) the electrically heated catalyst 140 is controlled by the ECU 81; however, it may be executed (controlled) by the HEV-CU 80.

Furthermore, the power consumption reduction and freezing prevention process described above may be configured to be executed (controlled) considering the outside air temperature, that is, for example, just during ultra-low temperatures.

Note that, in the above embodiment, the disclosure has been described with reference to its application to a four-cylinder engine; however, the disclosure is not limited to a four-cylinder engine and is applicable to other engines. Additionally, the disclosure is not limited to a horizontally opposed engine and can also be applied to engines with different configurations, such as an inline engine or a V engine. Furthermore, in the above embodiment, the disclosure has been described with reference to its application to an AWD vehicle (all-wheel drive vehicle); however, the disclosure can be applied to a 2WD vehicle (FF vehicle or FR vehicle).

According to the exhaust purification device according to the disclosure, first, after the vehicle is stopped and the engine is shut down, when (before) closing the first opening/closing valve and the second opening/closing valve, the electric motor is driven to motor the engine, and the residual combustion gas is discharged from inside the engine and the exhaust pipe and replaced with fresh air. Accordingly, combustion gas containing a large amount of water vapor is discharged and replaced with fresh air containing a small amount of water vapor, thereby reducing the amount of internal water vapor that could cause freezing, and preventing the freezing of components such as the first and second opening/closing valves.

Next, the second opening/closing valve is closed to heat the electrically heated catalyst to the first target temperature. Thereafter, when the temperature of the electrically heated catalyst reaches the first target temperature, the power supply to the electrically heated catalyst is stopped, and the first opening/closing valve is closed. In this way, after the electrically heated catalyst is heated to the first target temperature, the first and second opening/closing valves are closed (sealing the electrically heated catalyst). Thereafter, the temperature gradually decreases, causing the internal pressure to drop (depressurization), which reduces heat conduction through the air and improves thermal retention, thereby reducing the power consumption of the electrically heated catalyst. In particular, since the second opening/closing valve remains closed at that time (when the electrically heated catalyst is being heated), condensed water that accumulates in the rearward side of the exhaust pipe (such as in the muffler), where condensed water tends to accumulate, is evaporated again by the heat from the heating process. This prevents the condensed water from entering the second opening/closing valve and other components, thereby preventing freezing.

In this state, where the internal pressure is reduced, heat conduction is lowered (improving thermal retention), and the amount of internal water vapor is reduced, the electrically heated catalyst is sealed and thermally insulated to retain heat (i.e., a so-called thermos bottle structure is formed) by the exhaust pipe, which has the vacuum layer, along with the first opening/closing valve and the second opening/closing valve. This reduces the power consumption of the electrically heated catalyst, and even if the electrically heated catalyst is left under ultra-low temperatures for a long period, the first opening/closing valve and the second opening/closing valve are prevented from freezing and becoming unable to open.

According to the disclosure, in the exhaust purification device equipped with the electrically heated catalyst, it is possible to reduce the power consumption of the electrically heated catalyst, and prevent the exhaust pipe from becoming blocked due to the freezing of the opening/closing valves (plugs).

The HEV-CU 80 and the ECU 81 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the HEV-CU 80 and the ECU 81. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. An exhaust purification device configured to be installed in a vehicle, the vehicle comprising an engine and an electric motor capable of power transmission to and from a crankshaft of the engine, the exhaust purification device comprising:
an electrically heated catalyst configured to be heated by power supply, and to purify exhaust of the engine at a predetermined activation temperature or higher;
an exhaust pipe having a vacuum layer that covers at least an entire side surface of the electrically heated catalyst;
a first opening/closing valve disposed upstream of the electrically heated catalyst in the exhaust pipe and configured to open and close the exhaust pipe;
a second opening/closing valve disposed downstream of the electrically heated catalyst in the exhaust pipe and configured to open and close the exhaust pipe; and
a control unit configured to control the power supply to the electrically heated catalyst and driving of the first opening/closing valve and the second opening/closing valve,
wherein the control unit is configured to
when closing the first opening/closing valve and the second opening/closing valve after the vehicle is stopped and the engine is shut down,
drive the electric motor to motor the engine, discharge residual combustion gas from inside the engine and the exhaust pipe, and replace the residual combustion gas with fresh air,
then close the second opening/closing valve to heat the electrically heated catalyst to a first target temperature,
thereafter, when a temperature of the electrically heated catalyst reaches the first target temperature, stop the power supply to the electrically heated catalyst, and close the first opening/closing valve.

2. The exhaust purification device according to claim 1, wherein the control unit is configured to when the temperature of the electrically heated catalyst reaches the first target temperature and the power supply to the electrically heated catalyst is stopped, and the temperature of the electrically heated catalyst decreases from the first target temperature to a second target temperature, control the power supply to the electrically heated catalyst so as to maintain the second target temperature.

3. The exhaust purification device according to claim 2, wherein, the control unit is configured to control the power supply to the electrically heated catalyst such that the temperature of the electrically heated catalyst is maintained at the second target temperature until the engine is started next.

4. The exhaust purification device according to claim 3, wherein the control unit is configured to
when the first opening/closing valve and the second opening/closing valve are closed, and the engine is started next,
open the first opening/closing valve and the second opening/closing valve.

5. The exhaust purification device according to claim 4, wherein the control unit is configured to
when, upon controlling the power supply to the electrically heated catalyst such that the temperature of the electrically heated catalyst is maintained at the second target temperature, a charge amount of a battery supplying power to the electrically heated catalyst and the electric motor drops to a predetermined value or lower,
stop the power supply to the electrically heated catalyst, and open the first opening/closing valve and the second opening/closing valve.

6. An exhaust purification device configured to be installed in a vehicle, the vehicle comprising an engine and an electric motor capable of power transmission to and from a crankshaft of the engine, the exhaust purification device comprising:
an electrically heated catalyst configured to be heated by power supply, and to purify exhaust of the engine at a predetermined activation temperature or higher;
an exhaust pipe having a vacuum layer that covers at least an entire side surface of the electrically heated catalyst;
a first opening/closing valve disposed upstream of the electrically heated catalyst in the exhaust pipe and configured to open and close the exhaust pipe;
a second opening/closing valve disposed downstream of the electrically heated catalyst in the exhaust pipe and configured to open and close the exhaust pipe; and
circuitry configured to control the power supply to the electrically heated catalyst and driving of the first opening/closing valve and the second opening/closing valve,
wherein the circuitry is configured to
when closing the first opening/closing valve and the second opening/closing valve after the vehicle is stopped and the engine is shut down,
drive the electric motor to motor the engine, discharge residual combustion gas from inside the engine and the exhaust pipe, and replace the residual combustion gas with fresh air,
then close the second opening/closing valve to heat the electrically heated catalyst to a first target temperature,
thereafter, when a temperature of the electrically heated catalyst reaches the first target temperature, stop the power supply to the electrically heated catalyst, and close the first opening/closing valve.
